(19) United States
(12) Patent Application Publication
(10) Pub. No.: US 2011/0235761 A1
(43) Pub. Date: Sep. 29, 2011

(54) Method circuit and system for received signal noise reduction or cancellation

(76) Inventor: Roy Oren, Magshimim (IL)

(21) Appl. No.: 12/926,897

(22) Filed: Dec. 16, 2010

(30) Foreign Application Priority Data
Feb. 10, 2010 (CN) 201010116541.2

(51) Int. Cl. H04B 1/10

(52) U.S. Cl. 375/350

(57) ABSTRACT

Disclosed are methods, circuit and devices for received signal noise reduction of cancellation. There is provided a first and a second antenna spatially separated from one another. A noise extractor may generate a signal indicative of noise received at the second antenna, and a channel estimator may estimate one or more parameters of a channel between the first and the second antennas. A filter may modify the signal indicative of noise received at the second antenna using the one or more estimated channel parameters to generate a signal estimating noise received at said first antenna. A signal subtracting module may subtract from a signal received at the first antenna the signal estimating noise received at said first antenna.

### CROSS REFERENCE

The present application claims the benefit of Chinese Patent Application No. 201010116541.2 filed on Feb. 10, 2010; the disclosures of which are incorporated herein by reference.—

### FIELD OF THE INVENTION

The present invention relates generally to the field of wireless digital communication. More specifically, the present invention relates to canceling noise from a received data carrying radio frequency signal, for example from an orthogonal frequency-division multiplexing (OFDM) signal.

### BACKGROUND

Modern communication networks are characterized by features such as high bandwidth/data-rate, complex communication protocols, various transmission mediums, and various access means. Fiber optic networks span much of the world's surface, acting as long-haul networks for carrying tremendous amounts of data between distant points on the globe. Cable and other wire-based networks supplement coverage provided by fiber optic networks, where fiber networks have not yet been installed, and are still used as part of local area networks (“LAN”), for carrying data between points relatively close to one another. In addition to wire-based networks, wireless networks (e.g. GSM, CDMA, WCDMA, WiFi,) are used to supplement coverage for various devices (e.g. cell phones, wireless IP phones, wireless internet appliances) not physically connected to a fixed network connection. Wireless networks may act as complete local loop networks and may provide a complete wireless solution, where a communication device in a given area may transmit and receive data from another device entirely across the wireless network.

With the proliferation of communication networks and the world's growing reliance upon them, proper performance is crucial. High data rates and stable communication parameters at low power consumption levels are highly desirable for mobile communication devices. However, degradation of signal-to-noise ratio (“SNR”) as well as Bit energy to noise ratio (“Eb/No”) and interference ratios such as Carrier to-Interference (“C/I”) ratio occur to a signal carried along a transmission medium (e.g. coax, unshielded conductor, wave guide, open air or even optical fiber or RF over fiber). This degradation and interferences may occur in TDMA, CSMA, CDMA, EVDO, WCDMA and WiFi networks respectively. Signal attenuation and its resulting SNR degradation may limit bandwidth over a transmission medium, especially when the medium is air or open space.

Radio Frequency (“RF”) based wireless communication systems ranging from cellular communication systems to satellite radio broadcasting systems are highly prevalent, and their use is consistently growing. Due to the unshielded nature of the transmission medium of wireless RF based communication systems, they are particularly prone to various phenomena, including interference signals or noise and fading signals, which tend to limit performance of such systems.

Thus, strong and stable signals are needed for the proper operation of a wireless communication device. In order to improve the power level of signals being transmitted over relatively long distances, and accordingly to augment the transmission distance and/or data rate, devices may utilize power amplifiers to boost transmission signal strength. In addition to the use of power amplifiers for the transmission of communication signals, receivers may use low noise amplifiers and variable gain amplifiers (“VGA's”) in order to boost and adjust the strength and/or amplitude of a received signal.

An additional problem with wireless RF based transmissions is that they may be characterized by a multipath channel between the transmitter antenna and the receiver antenna which introduces “fading” in the received signal power.

Another problem with wireless RF based communication is the reception of weak signals accompanied by noise which, in many cases may even be stronger then the signal itself. The weak signal may be a result of a very long distance between the transmitter and the receiver, different obstacles (such as mountains, walls trees, etc.) blocking the signal going from the transmitter to the receiver, weather conditions, as well as other factors that cause the signal to be attenuated. The noise may be a result of other transmitters in the receiver's proximity, power line cables, electric machines, cars, microwave heaters, cosmic noise and many other sources of electromagnetic radiation.

The combination of attenuation, noise interference and “fading” is a substantial limitation for wireless network operators, mitigating their ability to provide high data-rate services such as Internet access and video phone services.

Therefore, there exists a need in the field of wireless communications for methods, circuits, devices and system for enhancing communication signal reception by a wireless receiver.

### SUMMARY OF THE INVENTION

The present invention is a system, circuit, device and method for canceling noise in a received RF (for example OFDM) signal. According to some embodiments of the present invention, there may be provided an RF receiver unit with two or more antennas spatially separated from one another. According to some embodiments of the present invention, a first antenna may be adapted to receive the signal and the noise. According to some embodiments of the present invention, a second antenna may be adapted to receive the noise. According to some embodiments of the present invention, there may be a sampling module or circuit associated with each of the antennas.

According to some embodiments of the present invention, there may be a time domain to frequency domain converter (for example Discrete Cosine or Fourier Transform logic circuit) or converting module associated with each of the sampling modules. According to some embodiments of the present invention, there may be a provided a frequency domain noise extracting (may also be referred to noise estimation) module associated with the time domain to frequency domain converting module which is associated with the first antenna.

According to some embodiments of the present invention, there may be provided a channel estimating module which may estimate the channel in the frequency domain between the first antenna and the second antenna. According to some embodiments of the present invention, there may be provided a filter which may adaptively filter the noise received at the second antenna in order to produce an estimate of the noise at the first antenna.

According to some embodiments of the present invention, there may be a subtracting module which may subtract the estimated frequency domain components of the noise from the frequency domain components of the signal+noise received at the first antenna.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a functional block diagram of an exemplary OFDM receiver which may be modified according to some embodiments of the present invention;

FIG. 1B is a signal diagram showing an exemplary received communication signal, received noise signal, and the combination of both as may be received by an RF receiver such as the one shown in FIG. 1A;

FIG. 2 is diagram depicting an exemplary use of two antennas as part of a receiver arrangement, in accordance with some embodiments of the present invention;

FIG. 3 is a schematic diagram of an exemplary system for noise reduction/cancellation according to some embodiments of the present invention;

FIG. 4 is a schematic diagram of an exemplary channel estimation module for estimating the channel between the two antennas according to some embodiments of the present invention;

FIG. 5 is a schematic diagram of an exemplary system for adaptive noise reduction/cancellation according to some embodiments of the present invention;

FIG. 6 is a schematic block diagram of an exemplary noise reduction system according to an embodiment of the present invention; and

FIG. 7 is a schematic block diagram of an exemplary noise reduction system according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

There may be provided a receiver including first and second antennas spatially separated from one another. A noise extractor may be adapted to generate a signal indicative of noise received at the second antenna, and a channel estimator may be adapted to estimate one or more parameters of a channel between the first and second antennas. A filter may be adapted to modify the signal indicative of noise received at said second antenna using the one or more estimated channel parameters to generate a signal estimating noise received at said first antenna. There may also be provided a a signal subtracting module adapted to subtract from a signal received at the first antenna the signal estimating noise received at said first antenna.

According to some embodiments, the receiver may include a sampling circuit functionally associated with each of the first and second antennas and a time domain to frequency domain conversion module associated with the output of the sampling circuit. The noise extractor may be adapted to operate in the frequency domain. The channel estimator may be adapted to operate in the frequency domain. The filter may be a digital filter and may be adapted to operate in the frequency domain.

According to some embodiments, the receiver may be an Orthogonal Frequency Division Multiplexing (“OFDM”) receiver, and the noise extractor and the subtracting module may be associated with a first sub-carrier of the OFDM receiver. A second noise extractor and a second subtracting module may be associated with a second subcarrier of the OFDM receiver.

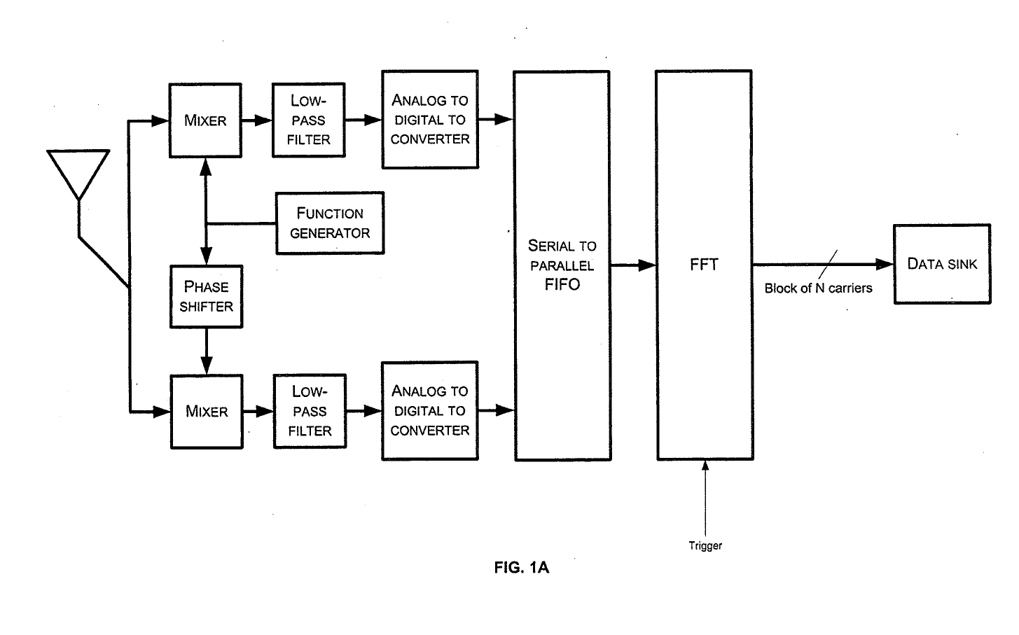

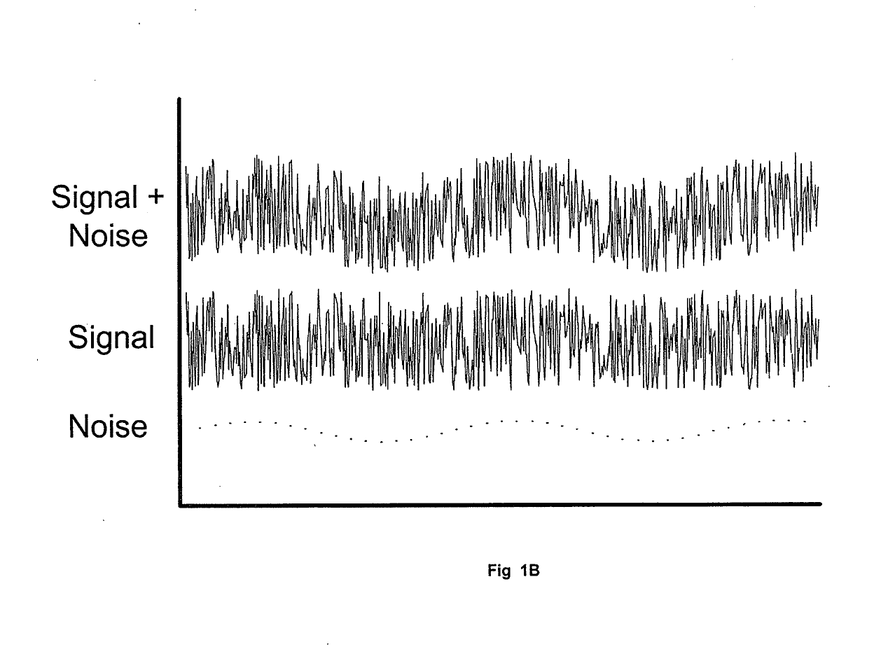

In wireless digital communication receivers, such as the OFDM receiver shown in FIG. 1A, signals at one or more carrier/sub-carrier frequencies may be received at the receiving antenna accompanied with some amount of noise. Since a received data stream may include data associated with multiple carriers, subcarriers or bins, a serial to parallel FIFO may be used to convert the received data stream into a set of carrier/subcarrier/bin specific data streams, where data belonging to each of the carrier/subcarrier/bin specific data streams are collected or aggregated into blocks of suitable for FFT processing. FFT processing performed on a block of data associated with a given carrier/subcarrier/bin may be used to recover the symbol/value transmitted on the given carrier/subcarrier/bin. FFT operates on blocks of data samples, per each input block it produces an output block, the output block is often referred to as a ‘symbol’. Each symbol may contain up to N carriers, and each carrier carries bits. There is trigger input needed for proper FFT operation as the blocks of samples are usually not consecutive but are parted by what is referred to as Guard interval. The FFT is usually triggered once every N*(1+GI) samples, where GI is a fraction (usually ¼ or ⅛ etc.).

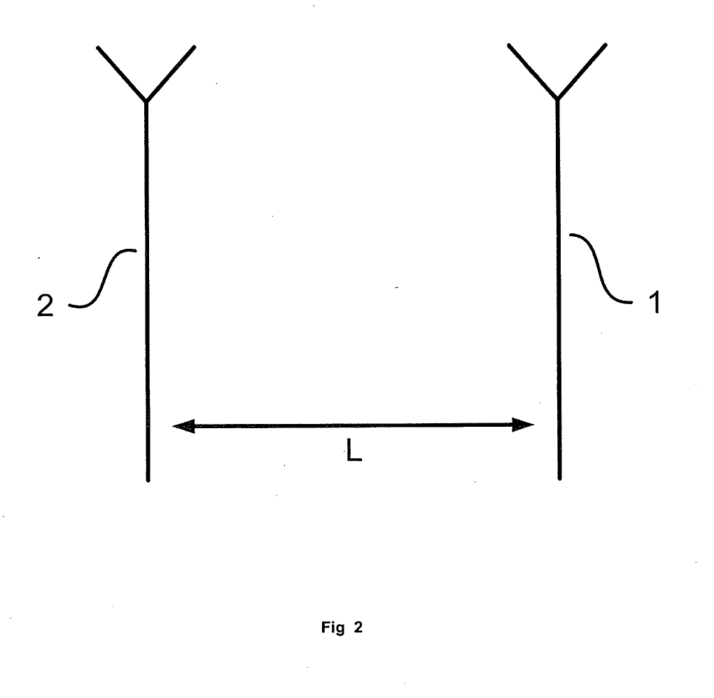

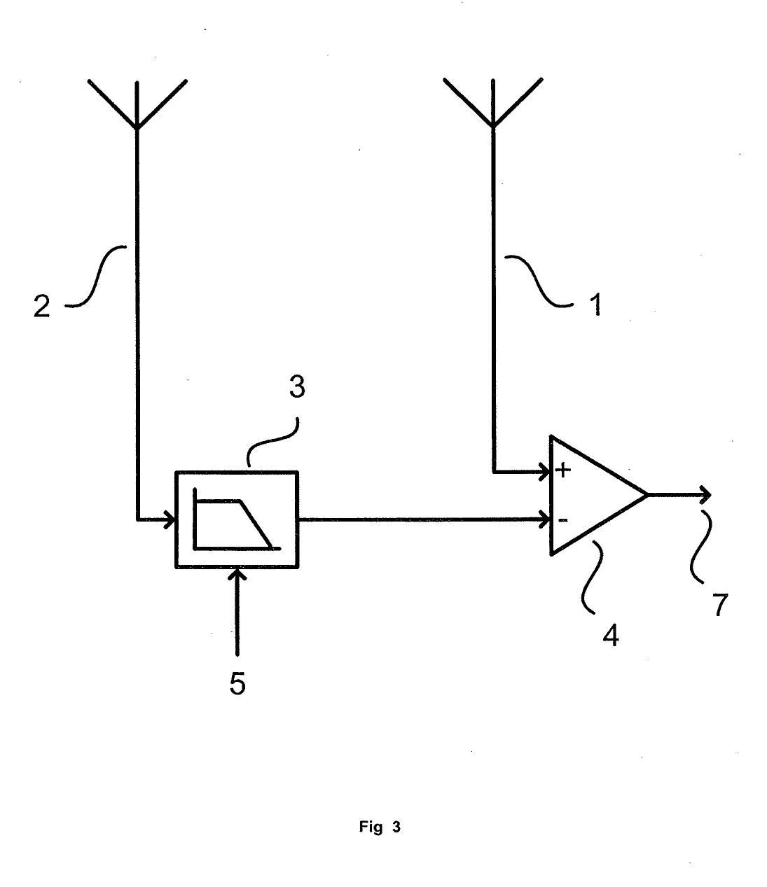

FIG. 1B shows an example of signal+noise which may be received at a receiver antenna. In order to filter out the noise and remain with a clean-as-possible signal, two antennas may be used. FIG. 2 describes the use of two antennas, where the first antenna (1) may serve to receive the original signal along with the accompanied noise, and the second antenna (2) may serve to receive the noise. The two antennas may be spaced by a distance “L’ from one another. Since both antennas may not be located at the same place and may not point to the same direction, the noise received at the first antenna may not be identical to the noise received by the second antenna (for instance it may be attenuated or amplified and/or phase shifted and/or delayed), therefore, the noise received at the first antenna may need to be estimated from the noise received at the second antenna. Once the noise at the second antenna has been estimated, it may be subtracted from the signal+noise received at that first antenna. FIG. 1B shows the estimated noise at the first antenna that may be received by the second antenna, and the signal which is the result of subtracting the estimated noise from the signal+noise received at the first antenna. FIG. 3 shows the noise estimation module (3) which may receive the noise that may be received at the second antenna (2) and estimate the noise that may be received at the first antenna (1). The estimated noise may then be subtracted by the subtracting module (4) from the signal+noise that may be received by the first antenna (1) to produce a clean signal at port 7.

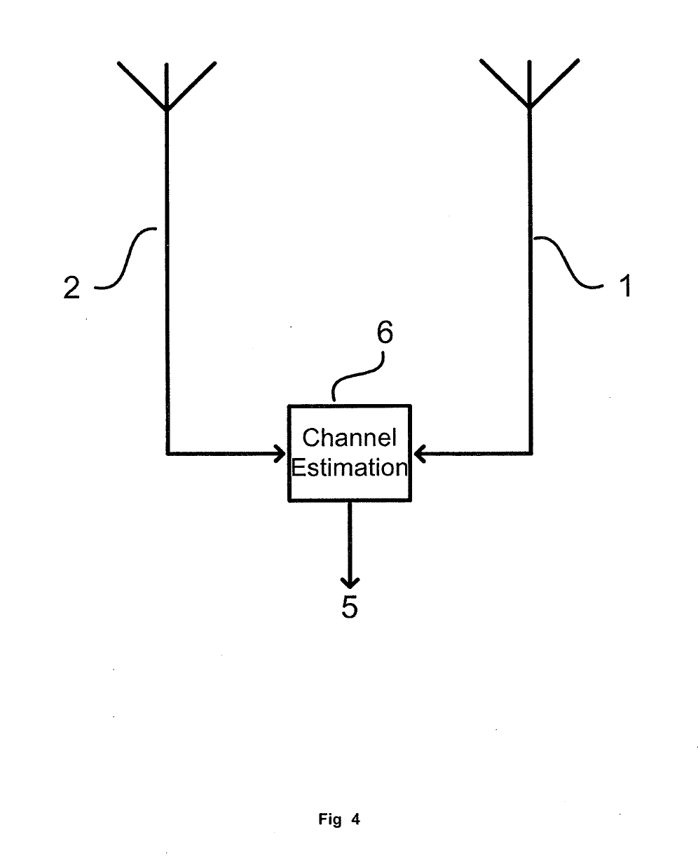

In order to estimate the noise at the first antenna from the noise received at the second antenna, the channel between the two antennas may need to be measured or estimated. There may be several techniques for measuring the channel, for example, in cases when there may be periodic quiet slots in which no signal is being transmitted, both the first antenna and the second antenna may receive only noise at the time of these quiet periods, and the difference in delay/phase and/or amplitude between the noise that may be received at the first antenna and the respective noise that may be received at the second antenna may determine the channel between both antennas. FIG. 4 shows a schematic diagram of an exemplary channel estimation module (6) which may receive the noise from the first antenna (1) and from the second antenna (2) and may calculate the channel parameters.

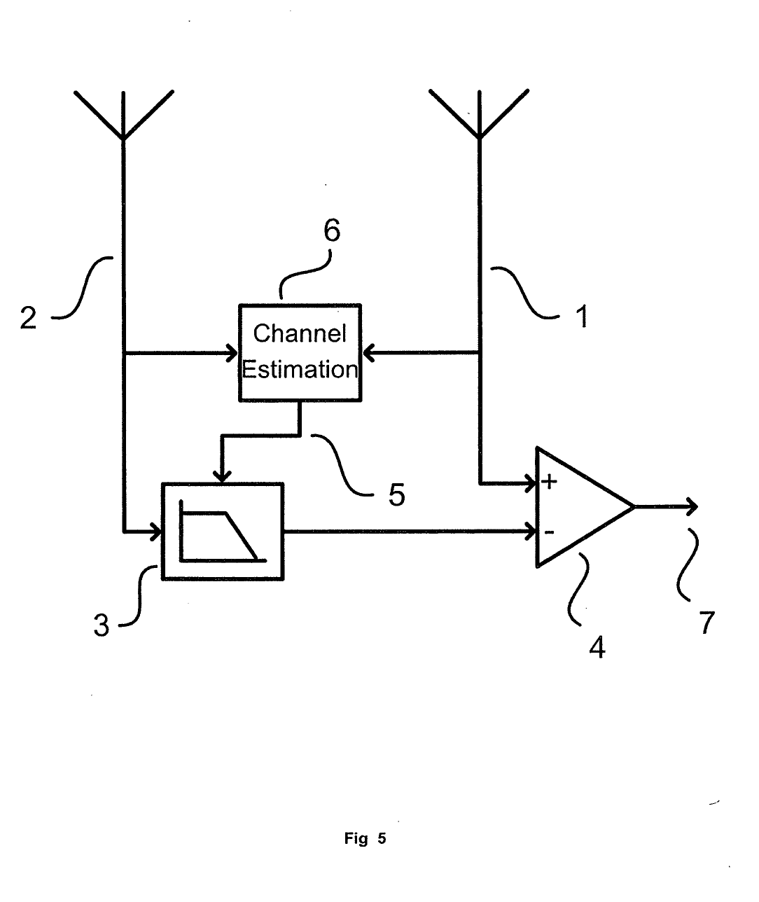

The channel may be continuously or intermittently estimated and may be provided to a filter, which filter may adaptively filter the noise received at the second antenna in order to produce an estimate of the noise at the first antenna. The estimated noise may then be subtracted from the signal+noise received at the first antenna in order to produce a clean signal. FIG. 5 describes the channel estimation module (6) that may receive the noise from the first antenna (1) and from the second antenna (2), and may continuously estimate the channel between the first and second antennas and send the estimated channel parameters (e.g. delay/phase and/or gain) over link 5 to the filter (3). The filter (3) may receive the noise signal from the second antenna (2) and may adaptively produce an estimated noise according to parameters that may continuously be provided to it from the channel estimation module (6) over link 5. The estimated noise signal produced by the filter (3) may be subtracted from the signal+noise that may be received at the first antenna (1) by the subtracting module (4) to produce a clean signal at the output (7).

In OFDM the received signal may be processed in the frequency domain. In order to process the signal in the frequency domain it may first need to be sampled (A/D) in the time domain, the samples may then be stored in some memory or register. When a certain number (N) of samples have been stored, a time domain to frequency domain conversion such as DFT—Discrete Fourier Transform or FFT—Fast Fourier Transform may be performed on the N stored samples to produce N components of the signal in the frequency domain. The N components in the frequency domain may then further be processed to calculate and/or filter required information. In order to perform the time domain to frequency domain conversion correctly, the N time domain sample window may need to be synchronized with the transmitter. There may be several techniques for synchronization of the sampling window in the time domain. One technique may be by using a known preamble or training sequence transmitted by the transmitter and having the receiver synchronize to that sequence. Another technique may be by using pilot carriers which may carry known data and having the receiver synchronize to that data. An OFDM signal consists of multiple carriers spaced apart in frequency. Every Kth carrier may be a pilot carrier which may carry data which is predefined and may be known both to the transmitter and receiver. By processing the signal that may be received at the first antenna in the frequency domain and subtracting the frequency components of the known data from the frequency components of the received pilot carriers, the noise at the pilot carriers in the first antenna may be extracted. By processing the noise that may be received at the second antenna in the frequency domain and comparing this noise in the pilot carriers to the extracted noise in the corresponding pilot carriers received at the first antenna, the channel between the first and second antenna may be estimated.

The estimation of the channel between the first and second antennas at the pilot carrier frequencies may consist 1) determining the gain/attenuation and 2) determining the delay which may result in shifting the sample window of the second antenna relative to the sample window of the first antenna. The channel in the other carrier (non pilot) frequencies may be determined by interpolation from the adjacent pilot carrier frequencies.

In a similar way, the channel may be estimated if one of the other known synchronization techniques such as training sequence or preamble, or any other synchronization technique which may be devised in the future is to be used.

Once the channel between the first and second antennas has been determined, the noise received at the second antenna can be used to cancel the noise received at the first antenna in the following way:

A block of N samples may be sampled from the first antenna and may be stored in memory. A block of N shifted in time samples may be sampled from the second antenna and may be stored in memory, the shift in time may be the determined delay between the first and second antennas. A time domain to frequency domain conversion such as FFT/DFT may be performed on the N samples from the first antenna and the N frequency domain components may be stored in a first memory location. A time domain to frequency domain conversion such as FFT/DFT may be performed on the N samples from the second antenna and the N frequency domain components may be stored in a second memory location. The frequency domain components from the second memory location may be multiplied by the corresponding channel gain for those frequencies and subtracted from the corresponding frequency domain components from the first memory location to produce the required symbols.

Alternatively, a time domain to frequency domain conversion such as FFT/DFT may simultaneously or almost simultaneously be performed on the N samples from the first antenna and on the N samples from the second antenna. The frequency domain components generated from the second antenna samples may be multiplied by the corresponding channel gain for those frequencies and subtracted from the corresponding frequency domain components generated from the first antenna samples to produce the required symbols.

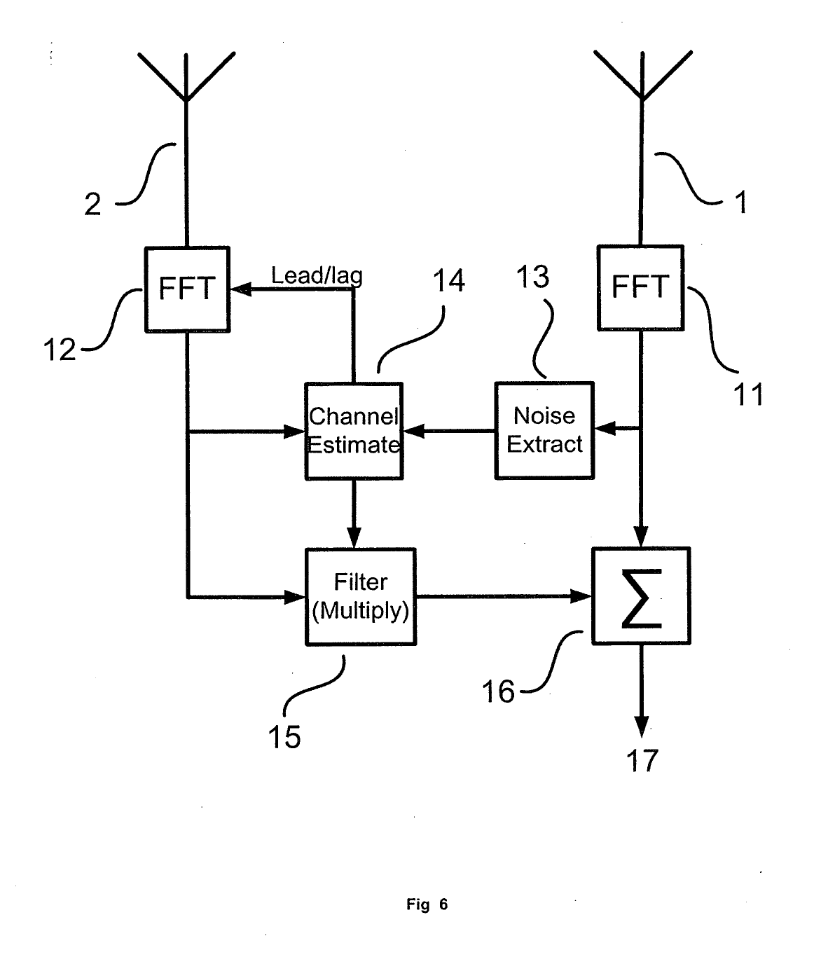

FIG. 6 is a schematic description of the frequency domain OFDM noise canceling system according to some embodiments of the present invention. Time domain to frequency domain conversion module 11 such as FFT/DFT may sample N samples from the first antenna (1) and perform a time domain to frequency domain conversion on those samples. The frequency domain components may be stored in memory in the time domain to frequency domain conversion module (11). Depending on the synchronization technique being used, the noise extraction module (13) may extract the noise components in the pilot frequencies or in the training sequence or preamble or in any other known synchronization data, by subtracting the frequency components of the known data from the frequency domain components of the received signal+noise in the pilot carriers or training sequence or preamble or any other technique known today or to be devised in the future. Time domain to frequency domain conversion module (12) such as FFT/DFT may sample N samples from the second antenna (2) and perform a time domain to frequency domain conversion on those samples. The frequency domain components may be stored in memory in the time domain to frequency domain conversion module (12). The channel estimation module (14) may compare the extracted noise components of the pilot carriers or the training sequence or preamble or other known data from the first antenna with the noise components of the pilot carriers or the training sequence or preamble or other known data from the second antenna to estimate the channel (gain and/or delay) between the first and second antennas at the pilot frequencies or at the training sequence or preamble or other known data. The channel estimation module (14) may further estimate the channel between the first and second antennas at the other (non pilot) frequencies by frequency domain interpolation. According to the estimated channel between the first and second antennas, the channel estimation module (14) may determine the amount of samples in which the time domain to frequency domain conversion module (12) may lead or lag the sampling window relative to the time domain to frequency domain conversion module (11). The frequency domain components from time domain to frequency domain conversion module 12 may then be multiplied by the channel coefficients calculated by the channel estimation module (14) to produce the frequency domain estimated noise components. The frequency domain estimated noise components may then be subtracted from the frequency domain components of the first antenna stored in the time domain to frequency domain conversion module (11) by a subtracting module (16) to produce the clean signal frequency domain components at output 17.

According to some embodiments of the present invention, there may be provided an RF OFDM receiver unit with two or more antennas spatially separated from one another. According to some embodiments of the present invention, a first antenna may be adapted to receive the signal and the noise. According to some embodiments of the present invention, a second antenna may be adapted to receive the noise. Furthermore, the terms ‘First Antenna’ and ‘Second Antenna’ throughout the description of the present invention are relative terms and are accordingly interchangeable.

According to an embodiment of the present invention, the noise may be canceled from the signal by processing the OFDM received signal in the frequency domain. According to some embodiments of the present invention, there may be a sampling module associated with each of the antennas. According to some embodiments of the present invention, the signal+noise at the first antenna and the noise at the second antenna may first be sampled (A/D) in the time domain. According to some embodiments of the present invention the time domain samples may then be stored in some memory or register file. According to some embodiments of the present invention, there may be a time domain to frequency domain converting module associated with each of the sampling modules. According to some embodiments of the present invention, after storing a certain number (N) of samples, a time domain to frequency domain conversion such as DFT—Discrete Fourier Transform or FFT—Fast Fourier Transform may be performed on the N stored samples to produce N components of the signal in the frequency domain for each of the associated antennas.

According to some embodiments of the present invention, the N components in the frequency domain may then be further processed to calculate and/or filter required information. According to some embodiments of the present invention, there may be a frequency domain noise extracting module associated with the time domain to frequency domain converting module which is associated with the first antenna. According to some embodiments of the present invention, the frequency components of the noise added to the known synchronization data received at the first antenna may be extracted by subtracting the frequency components of the known synchronization data from the frequency components of the synchronization data received at the first antenna.

According to some embodiments of the present invention, there may be a channel estimating module which may estimate the channel in the frequency domain between the first antenna and the second antenna. According to some embodiments of the present invention, the channel between the first and second antennas may be estimated in the frequency domain by processing the noise that may be received at the second antenna in the frequency domain and comparing this noise to the extracted noise in the corresponding known synchronization data received at the first antenna.

According to some embodiments of the present invention, the sampling window of the second antenna may be shifted relative to the sampling window of the first antenna according to the amount of advance or delay determined by the estimated channel between the two antennas. According to some embodiments of the present invention, the channel in non synchronization locations (frequencies or time) may be determined by interpolation.

According to some embodiments of the present invention, there may be a filter which may adaptively filter the noise received at the second antenna in order to produce an estimate of the noise at the first antenna. According to some embodiments of the present invention, the frequency domain components associated with the second antenna may be multiplied by the corresponding channel gain for those frequencies determined by the channel estimating module to produce an estimate of the frequency domain noise at the first antenna.

According to some embodiments of the present invention, there may be a subtracting module which may subtract the estimated frequency domain components of the noise from the frequency domain components of the signal+noise received at the first antenna. According to some embodiments of the present invention the frequency components of the estimated frequency domain noise may be subtracted from the corresponding frequency domain components associated with the first antenna to produce the required symbols.

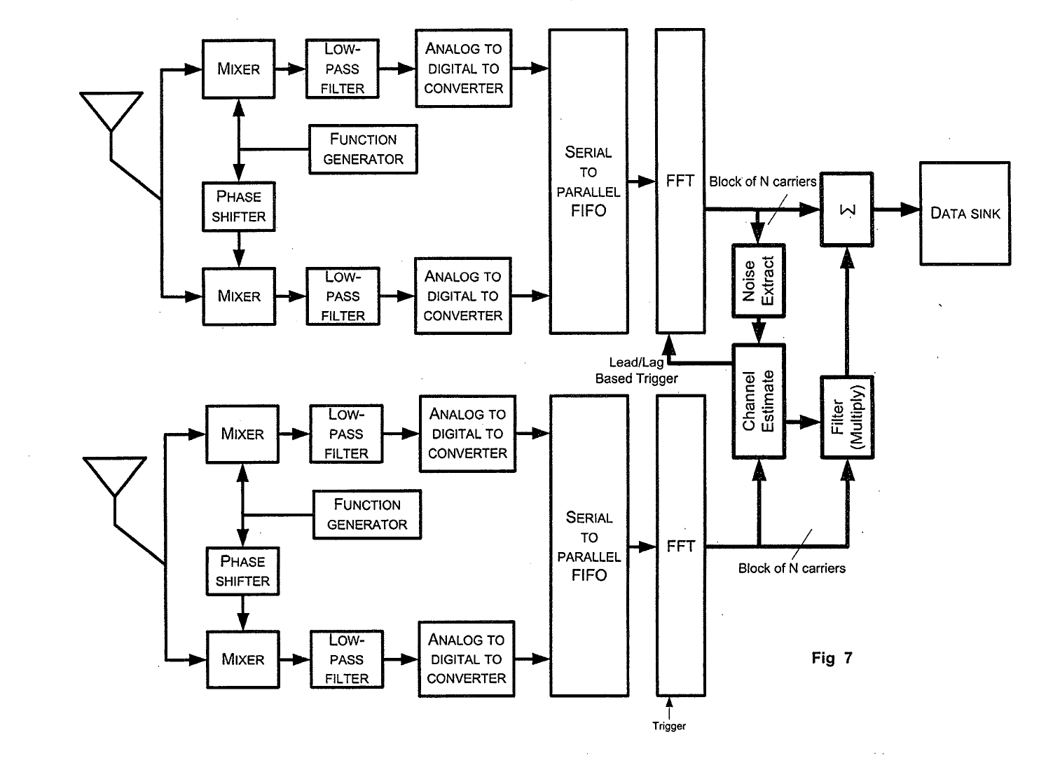

Turning now to FIG. 7, there is shown an implementation of the present invention as part of an OFDM receiver. For simplicity of illustration, noise reduction/cancellation blocks are shown with regard to all the sub-carriers or bins of the OFDM receiver. However, one or ordinary skill in the art would understand the applicability of the noise reduction blocks to two or more the sub-carriers/bins of the receiver. According to some embodiments of the present invention, the channel estimator provides lead or lag based trigger or marker to the FFT block of the signal receiver receive chain, where the trigger is based on the estimated channel between the two antennas. The trigger/marker is used to keep processing of received data blocks synchronized between the two (signal and noise) receive paths.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A receiver comprising:
first and second antennas spatially separated from one another;
a noise extractor adapted to generate a signal indicative of noise received at said second antenna;
a channel estimator adapted to estimate one or more parameters of a channel between said first and second antennas; and
a filter adapted to modify the signal indicative of noise received at said second antenna using the one or more estimated channel parameters to generate a signal estimating noise received at said first antenna.

2. The receiver according to claim 1, further comprising a signal subtracting module adapted to subtract from a signal received at said first antenna the signal estimating noise received at said first antenna.

3. The receiver according to claim 1, further comprising a received sampling circuit functionally associated with each of said first and second antennas and a time domain to frequency domain conversion module associated with the output of said sampling circuit.

4. The receiver according to claim 3, wherein said noise extractor is adapted to operate in the frequency domain.

5. The received according to claim 3, wherein said channel estimator is adapted to operate in the frequency domain.

6. The receiver according to claim 5, wherein said channel estimator is adapted to generate a lead or lag trigger indicative of a lead or lag between said first and second antennas

7. The receiver according to claim 3, wherein said filter is a digital filter adapted to operate in the frequency domain.

8. The receive according to claim 2, further comprising an Orthogonal Frequency Division Multiplexing (“OFDM”) receiver chain, and wherein said noise extractor and said subtracting module is associated with a first sub-carrier of said OFDM receiver.

9. A method of receiving comprising:
sampling signals received at first and second antennas spatially separated from one another;
generating a signal indicative of noise received at the second antenna;
estimating one or more parameters of a channel between the first and second antennas; and
modifying the signal indicative of noise received at said second antenna using the one or more estimated channel parameters in order to generate a signal estimating noise received at the first antenna.

10. The method according to claim 9, further comprising subtracting from a signal received at the first antenna the signal estimating noise received at said first antenna.

11. The method of claim 10, further comprising time domain to frequency domain conversion of the sampled signals.

12. The method to claim 11, wherein said noise extracting is performed in the frequency domain.

13. The method of claim 11, wherein said channel estimating is performed in the frequency domain.

14. The method of claim 13, wherein channel estimating includes generating a lead or lag trigger or marker indicative of a lead or lag between the first and second antennas.

15. The method of claim 14, wherein the trigger or marker are used to trigger FFT operation on data received on signal receive path.

16. The method of claim 11, wherein subtracting is performed in the frequency domain.

17. The method of claim 11, wherein modifying is performed in the frequency domain.
